(19) United States
(12) Patent Application Publication
(10) Pub. No.: US 2007/0031296 A1
(43) Pub. Date: Feb. 8, 2007

(54) IMPROVED TWO-PART MICROWELL PLATES AND METHODS OF FABRICATING SAME

(75) Inventors: Jeffrey Leonard Coulling, Kent (GB); Simon May, Surrey (GB)

Correspondence Address: WOOD, HERRON & EVANS, LLP, 2700 CAREW TOWER, 441 VINE STREET, CINCINNATI, OH, 45202, US

(73) Assignee: ADVANCED BIOTECHNOLOGIES LIMITED, Surrey (GB)

(21) Appl. No.: 11/461,476

(22) Filed: Aug. 1, 2006

(30) Foreign Application Priority Data
Aug. 2, 2005 (GB) GB0515820.9

(51) Int. Cl. B01L 3/00

(52) U.S. Cl. 422/102

(57) ABSTRACT

A multiwell plate assembly comprising: (i) one or more plate top portions, each plate top portion comprising a plurality of wells for holding chemical reactants, and a substantially planar deck portion connecting said wells in an ordered array, said deck portion comprising a top surface, a bottom surface and a perimeter; (ii) a substantially rigid frame portion for holding said plate top portion(s), said frame portion comprising an inner surface, an outer surface, a top surface and a bottom surface, an aperture in said top surface being adapted to accommodate one or more plate top portions; (iii) securing means adapted to secure the plate top portion(s) to the frame portion.

### FIELD OF THE INVENTION

The present invention relates to multi-well plates or titre plates used as containers for chemical or biological reactions, such as polymerase chain reactions (PCR) or for storage of chemical or biochemical samples, and to methods of manufacturing such plates. It is particularly applicable, but in no way limited, to rigid plastic PCR plates and to methods for their manufacture.

### BACKGROUND OF THE INVENTION

Multi-well plates, or two-dimensionally bound arrays of wells or reaction chambers, are commonly employed in research and clinical procedures for the screening and evaluation of multiple samples. Multi-well plates are especially useful in conjunction with automated thermal cyclers for performing the widely used polymerase chain reaction or “PCR”, and for DNA cycle sequencing and the like. They are also highly useful for biological micro-culturing and assay procedures, and for performing chemical synthesis on a micro scale.

Multi-well plates may have wells or tubes that have single openings at their top ends, similar to conventional test tubes and centrifuge tubes, or they may incorporate second openings at their bottom ends which are fitted with frits or filter media to provide a filtration capability. As implied above, multi-well plates are most often used for relatively small-scale laboratory procedures and are therefore also commonly known as “microplates”. Example multi-well plates are disclosed in EP 0638364, GB 2288233, U.S. Pat. No. 3,907,505 and U.S. Pat. No. 4,968,625.

Multi-well plates for PCR use are typically comprised of a plurality of plastic tubes arranged in rectangular planar arrays of typically 3×8 (a 24 well plate), 6×8 (a 48 well plate) or 8×12 (a 96 well plate) tubes with an industry standard 9 mm (0.35 in.) centre to centre tube spacing (or fractions thereof). As technology has advanced plates with a larger number of wells have been developed such as 16×24 (a 384 well plate).

In PCR multi-well plates, the bottoms of the tubes are generally of a rounded conical shape. They may alternatively be flat-bottomed (as typical with either round or square-shaped designs used with optical readers).

A horizontally disposed tray or plate portion generally extends integrally between each tube, interconnecting each tube with its neighbour in a cross-web fashion. The perimeter of the plate portion is commonly formed with a skirt extending downwardly beneath the plate portion. The skirt is integrally formed with the plate portion during moulding of the plate and generally forms a continuous wall of constant height around the plate. This skirt thus both lends stability to the plate when it is placed on a surface and some rigidity when the plate is being handled.

Research techniques that use multi-well plates include, but are not limited to, quantitative binding assays, such as radioimmuniassay (RIA) or enzyme-linked immunosorbant assay (ELISA), combinatorial chemistry, cell-based assays, thermal cycle DNA sequencing and polymerase chain reaction (PCR), both of which amplify a specific DNA sequence using a series of thermal cycles. Each of these techniques makes specific demands on the physical and material properties and surface characteristics of the sample wells. For instance, RIA and ELISA require surfaces with high protein binding; combinatorial chemistry requires great chemical and thermal resistance; cell-based assays require surfaces compatible with sterilization and cell attachment, as well as good transparency for certain applications; and thermal cycling requires low protein and DNA binding, good thermal conductivity, and moderate thermal resistance.

Compatibility of these plates with automated equipment has become increasingly important, since many laboratories automate the filling, and emptying of the wells, which often contain five microlitres or less, as well as their handling. Accordingly, it is desirable to use a multi-well plates that is conducive to use with robotic equipment and which can withstand robotic gripping and manipulation.

In the case of multi-well plates intended for PCR use there is a further important requirement, which is that the well walls should be as thin as possible. Such thin-well microplates are designed to accommodate the stringent requirements of thermal cycling and are designed to improve thermal transfer to the samples contained within the sample wells. The sample wells are typically conical shaped to allow the wells to nest into corresponding conical shaped heating/cooling blocks in the thermal cyclers. The nesting feature of sample wells helps to increase surface area of the thin-well microplates while in contact with the heating/cooling blocks and thus helps to facilitate heating and cooling of samples.

It will therefore be appreciated that thin-well microplates require a specific combination of physical and material properties for optimal robotic manipulation, liquid handling, and thermal cycling. These properties consist of rigidity, strength and straightness required for robotic plate manipulation; flatness of sample well arrays required for accurate and reliable liquid sample handling; physical and dimensional stability and integrity during and following exposure to temperatures approaching 100° C.; and thin-walled sample wells required for optimal thermal transfer to samples. These various properties tend to be contradictory. For instance polymers offering improved rigidity and/or stability typically do not possess the material properties required to be biologically compatible and/or to form thin-walled sample tubes.

Typically PCR plates are manufactured by one-piece polymer injection moulding because of the cost-effectiveness of this process. Various structural features are incorporated into the microplates in order to improve the strength, rigidity and flatness of the end product. For example, ribs may be incorporated into the underside of the multi-well plates to reinforce flatness and rigidity. However, such structural features are limited in their size and shape by the requirement that such plates must fit into thermal cyclers. A further option to enhance rigidity and flatness of multi-well plates includes using polymers that naturally impart rigidity and flatness to the plates. However, the selected polymer must also meet the physical and material property requirements of thin-well microplates in order for the plates to function correctly during thermal cycling.

In practice, most PCR plates in use today are manufactured from a polyolefine, typically polypropylene, in a one-shot injection moulding process. Polypropylene is used because the flow properties of molten polypropylene allow consistent moulding of a sample well with a wall that is sufficiently thin to promote optimal heat transfer when the sample well array is mounted on a thermal cycler block. In addition, polypropylene does not soften or melt when exposed to the high temperatures of thermal cycling. However, thin-well microplates constructed in this way from polypropylene possess inherent internal stresses which are to be found in moulded parts with complex features and which exhibit thick and thin cross sectional portions throughout the body of the plate. These internal stresses result from differences in cooling rates of the thick and thin portions of the plate body after the moulding process is complete. Furthermore, and equally if not more problematic, further distortions such as warping and shrinkage due to the release of these internal stresses can result when thin-well microplates are exposed to the conditions of the thermal cycling process. The resultant dimensional variations in both flatness and the footprint size can lead to unreliable sample loading and sample recovery when using automated equipment.

Various attempts have been made in the prior art to overcome these problems. One such example is described in EP 1198293 and US 2002/0151045 (M J Research Inc.) which describes a thin-well microplate formed from a skirt and frame portion which accommodates a separate well and deck portion, which may be joined to form the unitary plate. This design uses significantly more plastics material than the conventional design described above because the skirt and frame portion has a complete deck region having an array of holes, and is thus significantly more expensive to manufacture. Cost is a key factor since a high throughput laboratory may use tens of thousands of these thin-well microplates per week.

An alternative design is described in U.S. Pat. No. 6,669,911 (Swanson) which describes a rigid frame for holding a skirted multi-well plate planar. Once again there is additional plastics material used when compared with a conventional plate. This is because the well containing portion is itself fully skirted.

UK 2,288,233 (Akzo Nobel N. V.) describes a type of microtitre plate where an array of microtitre wells sit within a grid of square holes, each hole being adapted to accommodate a well. The grid of holes form an integrated part of a skirted frame portion. Such an arrangement would be impractical for PCR plates since the assembled unit would not and could not function within a thermal cycler.

It will therefore be appreciated that in several of the designs described above, the internal stresses present in a conventional thin-well plate are still present and an additional component has been employed in the hope of controlling these stresses during the thermal cycling process. Thus, in both prior art examples the inherent problem has not been resolved but is still present and an additional plastics or metal component has been added in an attempt to counteract the effect of the inevitable internal stresses.

It is an object of the present invention to overcome, or to at least mitigate, some or all of the problems described above.

### SUMMARY OF THE INVENTION

According to the present invention there is provided a multiwell plate assembly comprising:

(i) one or more top plate portions, each top plate portion comprising a plurality of wells for holding chemical reactants, and a substantially planar deck portion connecting said wells in an ordered array, said deck portion comprising a top surface, a bottom surface and a perimeter;

(ii) a substantially rigid frame portion for holding said plate top portion, said frame portion comprising an inner surface, an outer surface, a top surface and a bottom surface, an aperture in said top surface being adapted to accommodate one or more plate top portions;

(iii) securing means adapted to secure the plate top portion(s) to the frame portion.

Using this two-part construction the internal stresses can be minimised and the tendency for the plate assembly to warp or distort is much reduced. The frame portion can be formed with a thicker cross-section than the plate top portion without differential cooling rates causing a problem.

Preferably the securing means comprises a series of slots in the top surface of the frame portion and a series of co-operating lugs extending downwardly from the plate top portion on or near the perimeter of the plate top portion.

Lug and slot arrangements are easy, convenient and cost-effective to design and manufacture.

In an alternative arrangement the securing means comprises a series of slots in the plate top portion and a series of co-operating lugs extending upwardly on the frame portion. That is to say, reversal of the above arrangement is perfectly possible.

In a particularly preferred arrangement the slots take the form of apertures extending substantially entirely through the surface on which they are located.

Preferably one or more of said lugs incorporate a flange or hook such that the plate top portion forms a snap fit with the frame portion, and preferably the snap fit arrangement is irreversible. The flange or hook may take the form of a nib.

Preferably said frame portion comprises a base, a skirt region extending from said base, and an inward directing deck region extending substantially around the top perimeter of the skirt, said deck region being adapted to engage with the perimeter of the plate top portion when the plate assembly is in its assembled configuration.

Preferably said frame portion incorporates handling features for co-operation with a handling means of an automated machine.

Preferably said handling features comprise indentations in the exterior surface of the frame portion, and more preferably said indentations comprise apertures.

Preferably the surface of the frame portion comprises indexing marks that visually indicate the orientation of said plate assembly.

### BRIEF DESCRIPTION OF THE DRAWINGS

The present invention will now be described, by way of example, in relation to the accompanying drawings wherein:

FIGS. 1A and 1B illustrate top and edge elevations respectively of a frame portion;

FIG. 2 illustrates an enlarged cross-sectional view through an edge of the frame portion;

FIGS. 3A, 3B and 3C illustrates plan, end and edge elevations of a deck portion;

FIG. 4 illustrates an enlarged view of a retaining means on the perimeter of the planar deck portion;

FIG. 5 illustrates a well; and

FIG. 6 illustrates an enlarged cross-sectional view through the well body near its base, showing the conical section of least wall thickness.

FIG. 7 illustrates a plate top portion comprising a 12×2 array of 24 wells;

FIG. 8 illustrates an enlarged view of a further retaining means.

### DETAILED DESCRIPTION OF THE INVENTION

Preferred embodiments of the present invention will now be more particularly described, by way of example only. These represent the best ways known to the Applicant of putting the invention into practice but they are not the only ways in which this can be achieved.

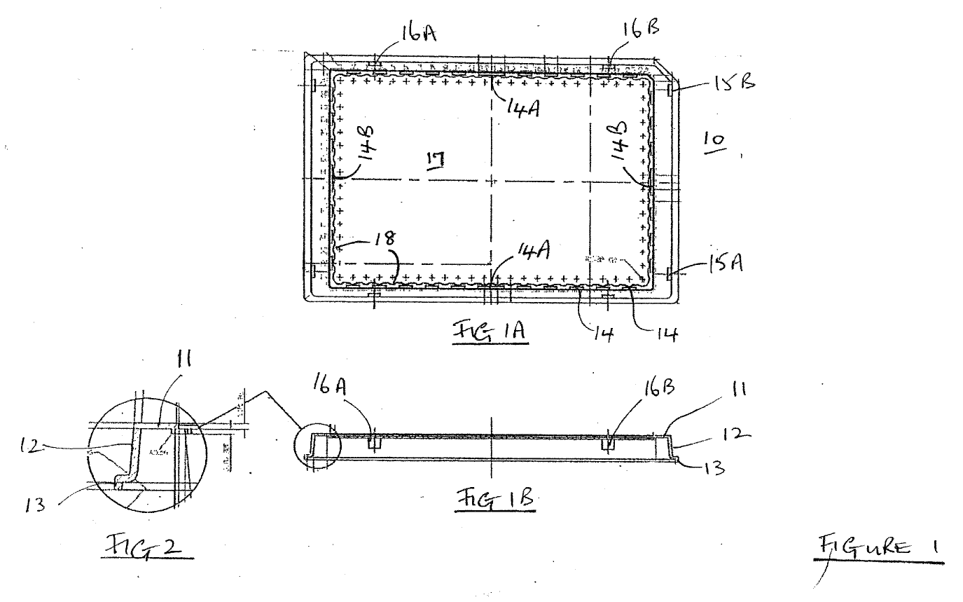

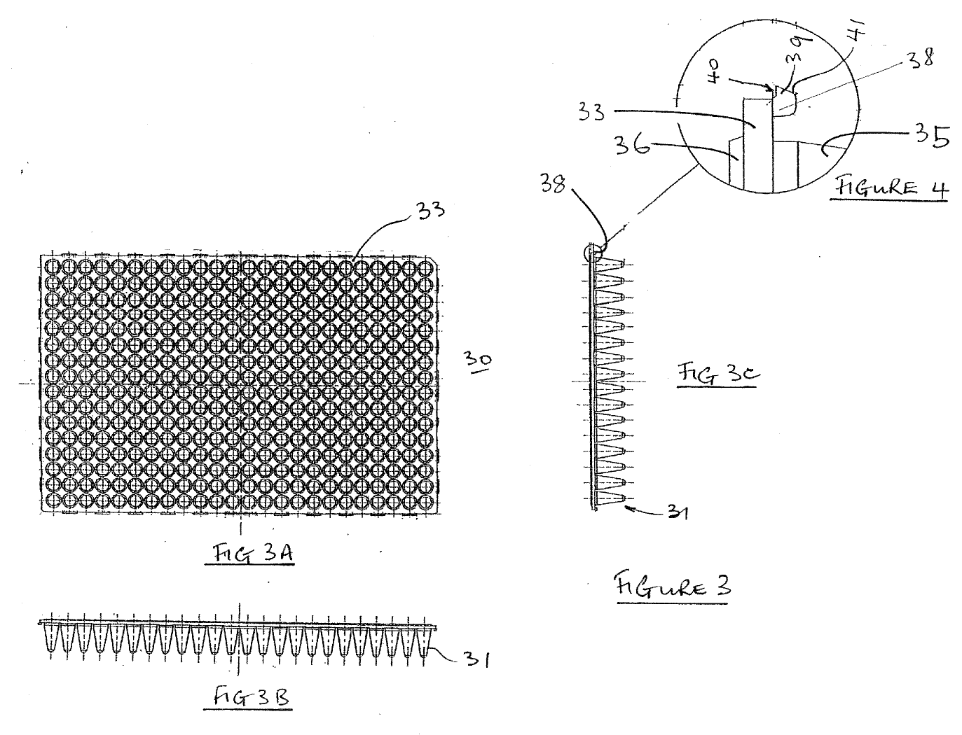

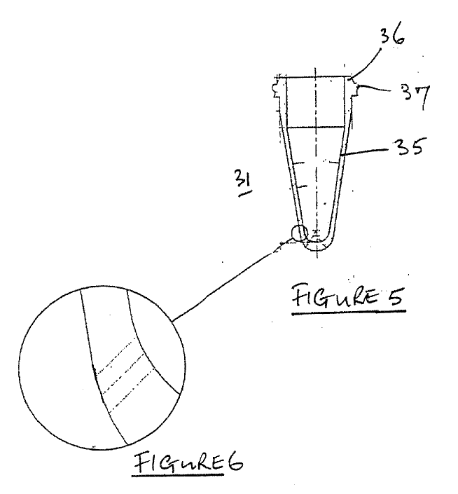

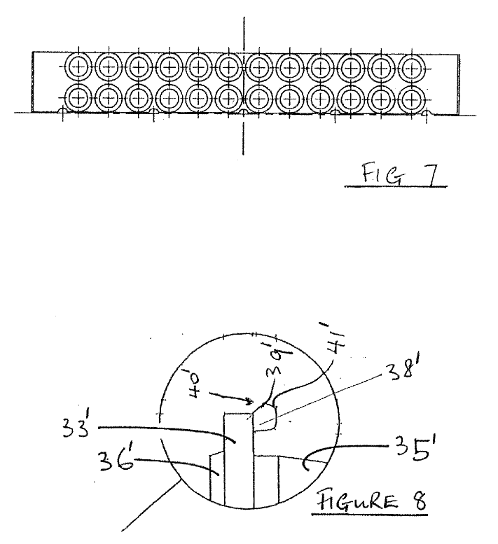

FIG. 1 illustrates various views of a frame portion 10 and FIG. 3 illustrations plan, side and end elevation views of a plate top portion 30 which together make up a multi-well plate assembly according to the present invention. The plate top portion comprises a plurality of individual wells 31, in this example 384 wells arranged in a regular array or matrix connected by a substantially planar deck portion 33. The body of each well 35 extends below the general plane of the deck portion and a small portion of each well, generally referred to as a chimney 36, extends above the plane of the deck.

The plate top portion 30 may be formed as a unitary piece or as a separate deck portion into which individual wells are fixed. That is to say, the deck and wells may be formed, for example by conventional injection moulding, as a single unitary component. Alternatively, the plate top portion can be formed from a separate deck component comprising a substantially planar sheet which includes an array of holes to accommodate an array of individual wells. In this example there is an array of 16 by 24 holes capable of receiving a 384-well array of sample wells. In another embodiment the plate top portion may include an array of holes with a total of 96 holes arranged in an array of 8 by 12 holes capable of receiving a 96-well array of sample wells. Although the array of holes or wells in the embodiment illustrated in FIGS. 1 and 3 is structured and configured to accommodate a 384-well array of sample wells, it is understood by those skilled in the art that the array of holes/wells may include any number of holes/wells to accommodate well arrays of higher or lower sample well density and may be arranged in alternative array patterns.

Referring to the individual holes in the deck component, these comprise a substantially circular openings integral with the top planar surface of the deck.

The circumference of each well may incorporate a flange 37, located in the region where the well is intended to engage with the deck portion. These flanges co-operatively engage with corresponding grooves in the circumference of the apertures in the deck portion to create a snap fit arrangement and to ensure that each well remains tightly in place in the deck portion once inserted into an aperture.

As an alternative to individual wells placed into an array of holes in a deck portion, strips or blocks of wells could be provided. This simplifies the assembly procedure in the event that the plate top portion is not formed of unitary construction. Forming the well into strips or blocks, as opposed to one array of say 96 wells or 384 wells filling the plate, offers a number of advantages. Firstly, it allows the user to choose the number of wells that they actually require for a particular investigation. In the case of a 96 well plate, 4×24 wells could be provided in 12×2 arrays. An example of such an array is shown in FIG. 7. It will be appreciated that a 3×8 array of 24 wells is also possible and that four of these arrays would also give 96 wells. Alternatively a 96 well plate could be formed from two 6×8 arrays or two 4×12 arrays. Similar divisions of a 384 well plate are possible.

It will therefore be appreciated that, regardless of whether the plate top portion is of unitary construction or formed from a combination of a separate deck portion and individual wells, it consists of a plurality of wells set in a substantially planar deck portion. One or more plate top portions may be used to make up a plate assembly. It will also be appreciated that only the body of the wells and the securing means (see below) extend below the general plane of the substantially planar deck portion 33. The planar deck is not skirted and the perimeter of the plate top portion thus lies in the same general plane as the body of the planar deck portion 33 itself.

Furthermore, the perimeter of the deck portion and therefore the perimeter of the plate top portion, incorporates a series of lugs 38, shown more clearly in FIG. 4. FIG. 4 illustrates a lug 38 extending generally downwardly from the edge of the plate top portion 33. The lug includes a nib formed by a sloping portion or face 39 and a substantially planar shoulder or face 40.

These lugs are designed and adapted to engage with corresponding slots 14 in the frame portion described in more detail below. This lug and slot arrangement is just one form of securing means which may be used to secure the plate top portion to the frame portion to make up a multi-well plate assembly according to this invention. It is intended that in this context the term “securing means” has a broad meaning and includes any arrangement which enables a plate portion to be secured, either temporarily or permanently, to a rigid frame portion. Thus the term “securing means” can include, but is not limited to clip means or a tongue and groove arrangement, or other interlocking means.

The frame portion 10 for holding the plate top portion 30 is made from a rigid material such as polycarbonate or polypropylene, including polypropylene incorporating a filler such as talc or glass, or polystyrene. The most appropriate material will be selected by the materials specialist and the above list is not intended to be exhaustive but merely illustrate the wide range of polymers which could find application here. It is specifically intended that this should include known polymers as well as those yet to be discovered.

The frame portion comprises a side wall or skirt region 12 having an outwardly extending flange 13 which forms a plate or foot substantially around the bottom perimeter of the flange portion, and an inwardly directed deck region 11 extending substantially around the top of the skirt region and directed towards the centre of the multiwell plate assembly. The central region 17 of the frame portion 10 comprises an aperture or void adapted to accept one or more plate top portions. The perimeter of this aperture includes a number of indentations 18. The profile of these indentations corresponds to the outer radius of a well 31 in the regional where the well meets the deck. One such indentation is provided for each well located at the edge of the array. Thus the inner surface of the aperture in the frame portion has the appearance of rounded castellations.

A series of slots 14 are formed around the edge of the deck region 11 and in this example these slots take the form of apertures extending through the body of the frame portion from an outer surface to an inner surface. In this example there are eleven slots along each long edge of the rectangular frame portion and seven slots along each short edge of the rectangular frame portion, making a total of thirty-six slots in all. These slots need not be uniform in their length, breadth and/or depth. For instance, in the example shown in FIG. 1, the slots 14A located at the mid-point of each long side is longer than the other slots along that side. Similarly the slots 14B located at the mid-point of each short side are longer than the other slots along that side.

The term “longer” or “length” when applied to these slots refers to the dimension of a slot along an axis parallel to the side of the frame portion to which that particular slot is associated. The term “breadth” in this context refers to the dimension of the slot along an axis perpendicular to the side of the frame portion to which that particular slot is associated.

In this example the slots are of substantially uniform breath. However, this need not be the case and the breadth of one or more slots may vary along the length of the slot.

These slots are designed to accept co-operating lugs on the plate top portion. Thus, a series of lugs or projections (thirty six in the current design) extend downwardly from the underside of the planar plate top portion and pass through the respective slots in the rigid frame portion. Moving the deck/well piece downwardly over the frame portion will cause the projections to pass downwardly through the slots and a sloped portion 39 of each projection will deform the frame outwardly. The combination of projections (eleven along each long side, seven along each short side) will deform the frame outwardly in all four directions. During assembly, the sloping face 39 serves to deform the frame portion slightly as the lugs are inserted into their respective holes during assembly. Prior to assembly, the bottom of the lug 41 sits in or over an aperture and continued movement forcing the plate top portion and the frame portion together causes the edge of the aperture to ride over the sloping face of the lug 39. Eventually the underside of the aperture 14 passes across the shoulder 40 and a snap fit has been achieved. Generally this snap fit arrangement is not reversible. That is to say, because of the shape of the exterior side of each projection i.e. the slope and step arrangement, the interlock is irreversible. It will also be appreciated that by varying the size and shape of the shoulder 40′ that this securing means arrangement could also be made reversible. Such an arrangement is shown in FIG. 8 where shoulder 40 is chamfered such that pressure applied from the underside of the wells will cause the frame portion to flex and the plate top portion 33′ to separate from the frame portion.

It will also be appreciated that it is not necessary or essential to use slots. The edge of the deck region itself can be adapted to engage with lugs on the plate top region. This may simplify manufacture considerably. It also allows for registration of the plate portion(s) with respect to the frame portion by means of registration means. This registration means may comprise, for example, interengaging ribs and grooves on the abutting components which tend to bias the components back to their original alignment during and post thermal cycling.

The side wall or skirt region 12 of the frame portion also incorporates robotic handling notches 15A, 15B, 16A, 16B. The shape, extent and placing of these holes is shown more clearly in FIG. 1B for those holes 16A, 16B positioned along the long edge of the frame portion. Such robotic handling notches are well known in this field and can take a number of forms. That is to say, the number, size, shape and location of such notches can vary, depending on type and set up of the robotic handling system with which the plates may be used.

This arrangement brings with it a number of advantages. The two or more mouldings that make up the multi-well plate assembly are simple to mould and do not undergo significant moulding stresses. It will be appreciated that parts that do undergo significant stresses during moulding such as conventional fully skirted PCR plates tend to release their stresses when heated i.e. during PCR thermal cycling processes, resulting in distortion. Therefore, in addition to the fact that the frame is moulded from a rigid material which in itself prevents distortion, the fact that all parts are simple mouldings further reduces their tendency to warp or distort when heated.

Furthermore, the nature of the way the top plate portion(s) and the frame portion are joined together allows for small amounts of movement during the PCR heating/cooling cycles. If the two parts were moulded as one, as in a conventional multi-well plate, there would be no such flexibility. This flexibility therefore minimises distortion of the composite plate as a whole, because each individual component is allowed to relax/move slightly and therefore does not put additional stresses or forces on the other part.

Furthermore, because top plate portion(s) and the frame portion are moulded separately from one another and joined together post-moulding during the manufacturing process, if there is a hole or defect in one of the portions, this can be discarded without having to sacrifice the other component. This feature can save a significant cost during the manufacturing process.

1. A multiwell plate assembly comprising:
(i) one or more plate top portions, each plate top portion comprising a plurality of wells for holding chemical reactants, and a substantially planar deck portion connecting said wells in an ordered array, said deck portion comprising a top surface, a bottom surface and a perimeter;
(ii) a substantially rigid frame portion for holding said plate top portion(s), said frame portion comprising an inner surface, an outer surface, a top surface and a bottom surface, an aperture in said top surface being adapted to accommodate one or more plate top portions;
(iii) securing means adapted to secure the plate top portion(s) to the frame portion.

2. A multiwell plate assembly as claimed in claim 1 wherein the securing means comprises a series of slots in the top surface of the frame portion and a series of co-operating lugs on or near the perimeter of the plate top portion.

3. A multiwell plate assembly as claimed in claim 1 wherein the securing means comprises a series of slots in the plate top portion and a series of co-operating lugs on the frame portion.

4. A multiwell plate assembly as claimed in claim 2 wherein the slots take the form of apertures extending substantially entirely through the surface on which they are located.

5. A multiwell plate assembly as claimed in claim 3 wherein the slots take the form of apertures extending substantially entirely through the surface on which they are located.

6. A multiwell plate assembly as claimed in claim 2 inclusive wherein one or more of said lugs incorporate a flange or hook such that the plate top portion forms a snap fit with the frame portion.

7. A multiwell plate assembly as claimed in claim 3 wherein one or more of said lugs incorporate a flange or hook such that the plate top portion forms a snap fit with frame portion.

8. A multiwell plate assembly as claimed in claim 7 wherein the snap fit arrangement is irreversible.

9. A multiwell plate assembly as claimed in claim 7 wherein the snap fit arrangement is irreversible.

10. A multiwell plate assembly as claimed in claim 2 wherein said frame portion comprises a base, a skirt region extending from said base, and an inward directing deck region extending substantially around the top of the skirt, said deck region being adapted to engage with the perimeter of the plate top portion when the plate assembly is in its assembled configuration.

11. A multiwell plate assembly as claimed in claim 1 wherein said frame portion incorporates handling features for co-operation with a handling means of an automated machine.

12. A multiwell plate assembly as claimed in claim 11 wherein said handling features comprise indentations in the exterior surface of the frame portion.

13. A multiwell plate assembly as claimed in claim 12 wherein said indentations comprise apertures.

14. A multiwell plate assembly as claimed in claim 1 wherein the surface of the frame portion comprises indexing marks that visually indicate the orientation of said plate assembly.

15. A multiwell plate assembly comprising:
(i) one or more plate top portions comprising a plurality of wells for holding chemical reactants;
(ii) a frame portion for holding said plate top portion(s), an aperture in said frame portion being adapted to accommodate one or more plate top portions.

16. A multiwell plate assembly as claimed in claim 15 further comprising a securing means adapted to secure the plate top portion(s) to the frame portion.

17. A multiwell plate assembly as claimed in claim 16 wherein the securing means comprises a series of co-operating lugs and slots.

18. A multiwell plate assembly as claimed in claim 17 wherein one or more of said lugs incorporate a flange or hook such that the securing means creates a snap fit.

19. A multiwell plate assembly as claimed in claim 18 wherein said snap fit is irreversible.
